(19) United States
(12) Patent Application Publication
(10) Pub. No.: US 2013/0088113 A1
(43) Pub. Date: Apr. 11, 2013

(54) MOTOR HAVING MORE MAGNETS ON EFFECTIVE AREA OF THE ROTOR THEREOF

(71) Applicants: Wen-Ho Yu, Kuan Yin Hsiang (TW); Fu-Rong Chen, Kuan Yin Hsiang (TW); Chen-Nan Chu, Kuan Yin Hsiang (TW); Wei-Hsun Lee, Kuan Yin Hsiang (TW)

(72) Inventors: Wen-Ho Yu, Kuan Yin Hsiang (TW); Fu-Rong Chen, Kuan Yin Hsiang (TW); Chen-Nan Chu, Kuan Yin Hsiang (TW); Wei-Hsun Lee, Kuan Yin Hsiang (TW)

(21) Appl. No.: 13/253,217

(22) Filed: Oct. 5, 2011

(51) Int. Cl. H02K 1/27

(52) U.S. Cl. 310/156.38

(57) ABSTRACT

A motor having more magnets on effective area of the rotor includes a stator, a rotor and a rotation shaft, the rotor has a plurality number of rotor magnetic poles, a magnet is installed inside each of rotor magnetic pole, and a concave arc is on the outer side of each magnet and forms the first, the second and the third surfaces near inside of each magnet. The concave arc connects to the first and the third surfaces with a connecting plan respectively, each connecting plan nears the periphery surface of the rotor. The motor has more magnets on the effective area of the rotor for higher motor efficiency.

### BACKGROUND OF THE INVENTION

1. Field of the Invention

The present invention relates to a motor, in particular a motor having more magnets on effective area of the rotor to improve efficiency of the motor thereof.

2. Description of the Related Art

Heretofore, it is known in modem industry that power is needed to drive machinery in rotation or movement in other forms, motors are generally applied as power source; motors can convert electrical power or magnetic energy into mechanical power, motors are widely applied in different variety of industries, electrical appliances, transportation systems, and have become an indispensable device.

Motors can be classified into DC, AC, brushless and brush types, in general, the structure of the motor consists of a rotor and a stator, magnetic flux distribution between rotor and stator activates rotor rotate, the rotation of motor transmits and provides mechanical energy needed. Magnet has magnetic characteristics, permanent magnet motor applies magnetic flux provided by magnet, permanent magnet motors can produce larger torque within the limited space with higher efficiency and more precision, so they own more attention in the market.

Refer to FIG. 1, the structure diagram of the known first type permanent magnet motor 10 of, consisting of a rotor 11 and a stator 12, the rotor 11 consists of a plurality number of magnets 111, stator 12 is in a round structure with a plurality number of stator magnetic poles 121 on the upper inner rim, the stator magnetic poles 121 is surrounded with coil, after rotor 11 and stator 12 are placed together, air gap is formed between rotor 11 and stator 12, when electrical current passes through coil, the stator poles 121 made of magnetic material react with magnet 111 of the rotor 11 by magnet effect, and activates rotational motion; an axis 13 of the rotor 11 can transmit mechanical energy when the rotor 11 rotates, for further application.

Refer to FIG. 1, the rotor 11 has a plurality number of rotor poles 112, a four-pole motor as example consisting of four rotor poles 112, the shape of the magnet 111 of the rotor pole 112 has arc cross section (consists of two curves with different radius). Magnets 111 are installed inside the rotor 11 with high mechanical strength, installation and processing is relatively simple, cost is low. The effective space for magnet is smaller that causes less magnetic flux, and cannot fully enhance the efficiency of the motor.

As shown in the FIG. 2, a Taiwan patent No. 582670 with the name “Motor of permanent magnet rotor”, also consists of a rotor 11, and a stator 12, a plurality number of magnets 111 installed on the rotor 11, the shape is in fan cross section. The effective space for the magnet is larger, but is easily to introduce running noise

### SUMMARY OF THE INVENTION

In view of the aforementioned problems of the prior art, it is a primary objective of the present invention to provide a motor with rotor having more magnets on an effective surface for higher efficiency.

To achieve the foregoing objective, the present invention consists of a stator, a rotor and a rotation shaft, the rotor forms a plurality number of rotor poles, each rotor pole has a magnet, a concave arc is on the outer side of each magnet, and forms the first, the second and the third surfaces near inside of each magnet, the concave arc connects to the first and the third surfaces with connecting plans respectively, each connecting plan nears the periphery surface of that rotor, the angles formed by the first surface, the third surface with the second surface are θ1, and θ3 respectively, when the number of rotor magnet poles is P that satisfies “90+ (180/P)” degree condition, the slope of the tangent of the concave arc near the first surface is equal or smaller than the slope of the first surface, the slope of the tangent of the concave arc near the third surface is equal or smaller than the slope of the third surface, the magnet design makes rotor have more area for magnets on effective surface to lift the efficiency of motor, and reduce rotation noise.

### BRIEF DESCRIPTION OF THE DRAWINGS

The accomplishment of the above-mentioned object of the present invention will become apparent from the following description and its accompanying drawings which disclose illustrative an embodiment of the present invention, and are as follows:

FIG. 1 is a structure diagram of motor rotor and stator of the first prior art;

FIG. 2 is a structure diagram of motor rotor and stator of the second prior art;

FIG. 3 is a perspective view of motor rotor and stator of the first preferred embodiment;

FIG. 4 is a structure perspective view of magnet of the first preferred embodiment of the present invention;

FIG. 5 is a perspective view of motor rotor and stator of the second preferred embodiment of the present invention;

FIG. 6 is a efficiency waveform chart of motor (as shown in FIG. 1) the first prior art and the present invention;

FIG. 7 is a Cogging Torque waveform of the corresponding rotor positions of the first known prior art and the preferred embodiment of the present invention;

FIG. 8 is a Cogging Torque waveform of the corresponding rotor positions in accordance with the preferred embodiment of the present invention;

FIG. 9 is a Cogging Torque waveform of the corresponding rotor positions of the second known prior art and the preferred embodiment of the present invention.

### DETAILED DESCRIPTION OF THE PREFERRED EMBODIMENTS

The technical content of the present invention will become apparent by the detailed description of the following embodiments and the illustration of related drawings as follows.

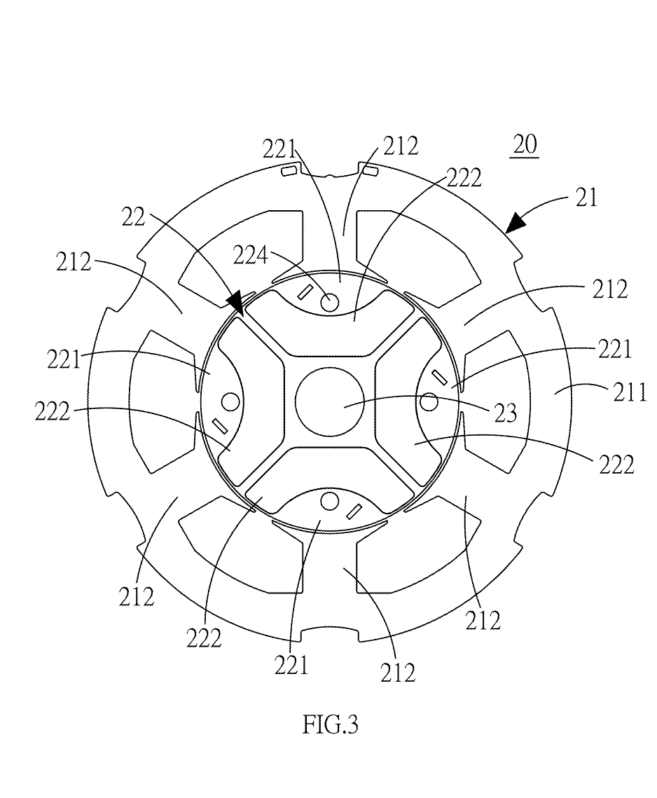

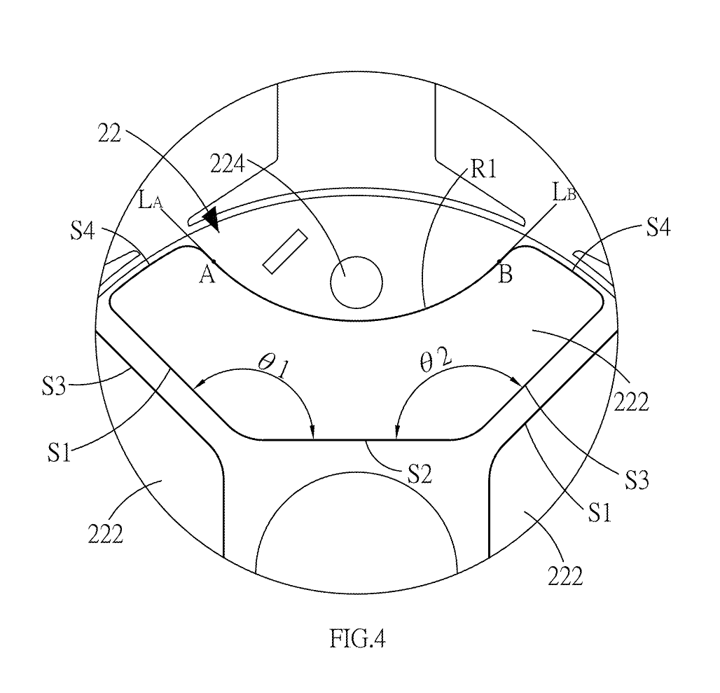

The present invention improves regular motors, with reference to FIG. 3 and FIG. 4, the present invention comprises of a stator 21, a rotor 22 and a rotation shaft 23;

The stator 21 further consists of a round shape main body 111 and a plurality number of stator magnetic poles 212, all stator magnetic poles 212 are protruding installed inside the round shape main body 211, a storage space is within each of the stator magnetic pole 212.

The rotor 22 is installed inside the storage space and form air gap with each stator magnetic pole 212, the rotor 22 has an even number of rotor magnetic poles 221, magnets 222 are inside the rotor magnetic poles 221.

The rotor magnetic poles 221 are installed in even number, when the number of rotor magnetic poles 221 is P, the number of stator magnetic pole is “P+ (P/2)”, the implementation of the present invention has a four-pole motor as example, there are four rotor magnetic poles 221 and four stator magnetic poles 212.

Even number of magnets are each installed inside a rotor magnetic pole 221, magnets 222 are made of iron oxide material, a concave arc R1 is on the outer side of each magnet 222, and forms the first, the second and the third surfaces S1, S2, S3 near inside of each magnet 222, the concave arc connects R1 to the first and the third surfaces S1, S3 with a connecting plan S4 respectively, each connecting plan S4 nears the periphery surface of that rotor 22, the angles formed by the first surface, the third surface S1, S3 with the second surface S2 are θ1, and θ3 respectively, when the number of rotor magnet poles 221 is P that satisfies “90+ (180/P)” degree condition, as example shown in fig, P=4, θ1=θ 3=135°, the slope of the tangent (L_{A}) of the concave arc R1 near the end A of the first surface S1 is equal or smaller than the slope of the first surface S1, the slope of the tangent (L_{B}) of the concave arc R1 near the end B the third surface S3 is equal or smaller than the slope of the third surface S3, the first surface and the third surface S1, S3 of adjacent magnets 222 are parallel to each other.

The rotation axis 23 is installed on the center of rotor 22 and forms a body with the rotor 22.

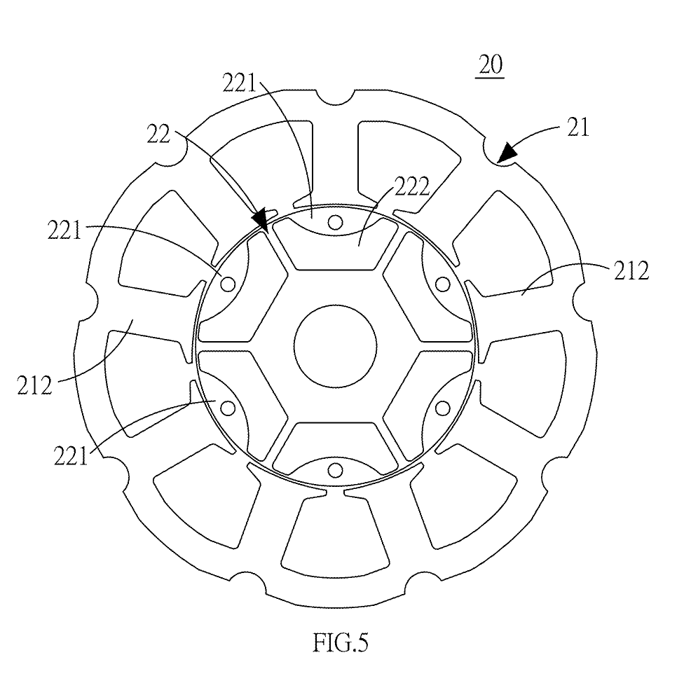

The second application sample shown in FIG. 5, the motor 20 has six poles with six rotor magnetic poles 221, and nine stator magnetic poles, the magnets 222 on the rotor magnetic poles 221 meet the same criteria.

The implementation of the present invention, the magnet design makes rotor have more magnets applied on the effective surface to lift the efficiency of motor, and reduce rotation noise.

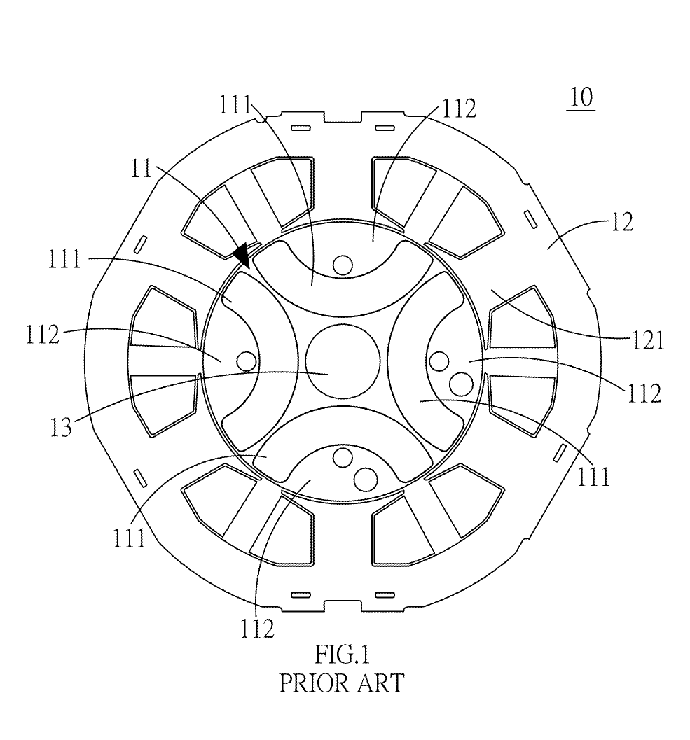

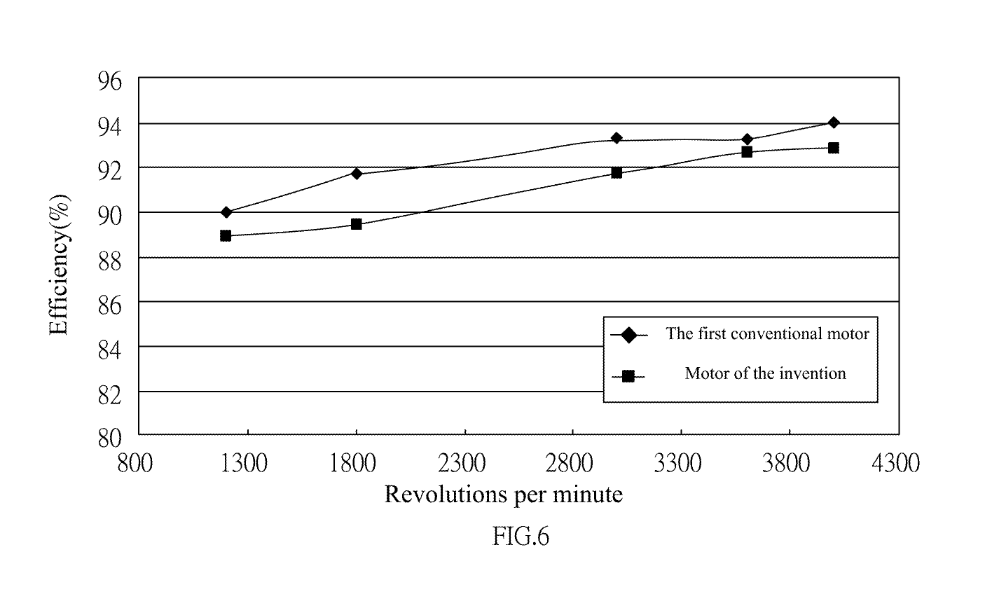

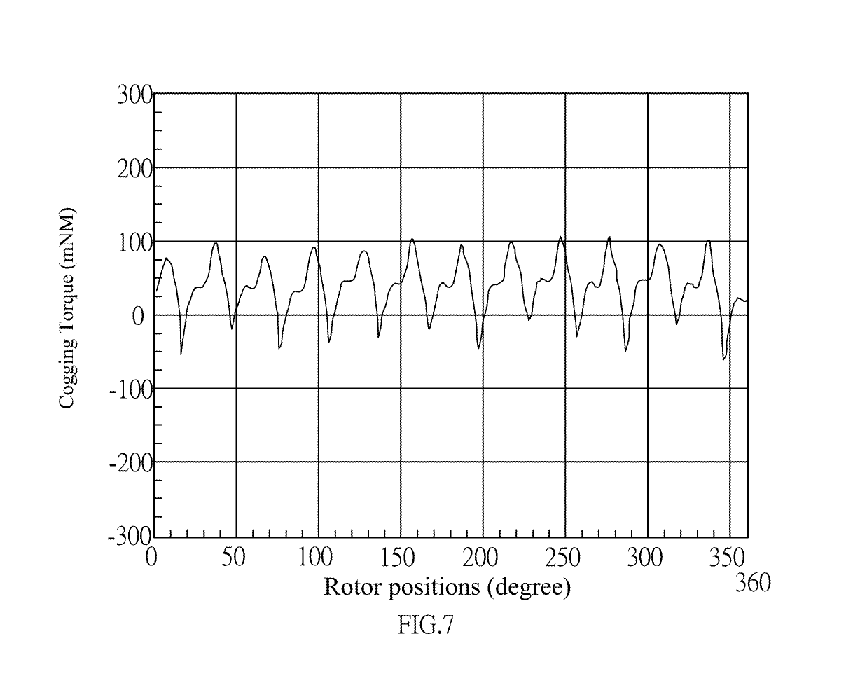

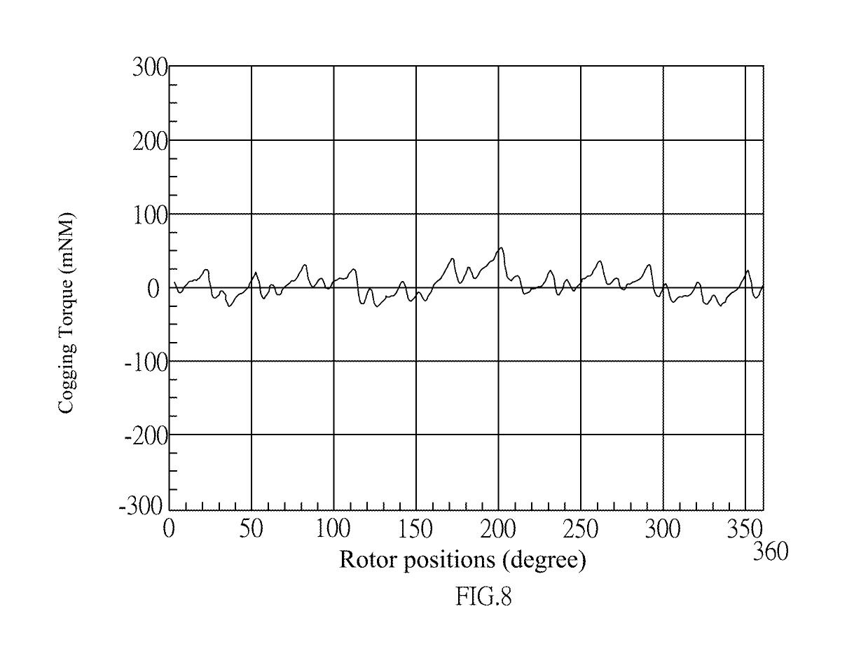

Refer to FIG. 6, an efficiency chart explaining the first known prior art (as shown in FIG. 1) and the embodiment of the present invention. As shown in the figure, under same rpm (Revolution per minute), the embodiment of the present invention has higher efficiency. FIG. 7 is a Cogging Torque waveform of the corresponding rotor positions of the first known prior art (as shown in FIG. 1) and the embodiment of the present invention. FIG. 8 is a Cogging Torque waveform of the corresponding rotor positions of the embodiment of the present invention, the Cogging Torque is the torque between rotor magnets and stator teeth slots while motor is not activated, the value influences the vibration noise of motor, the higher the value influences efficiency of motor or the generation of vibration, noise is more serious, the lower the value reduces the chance of vibration, noise produced.

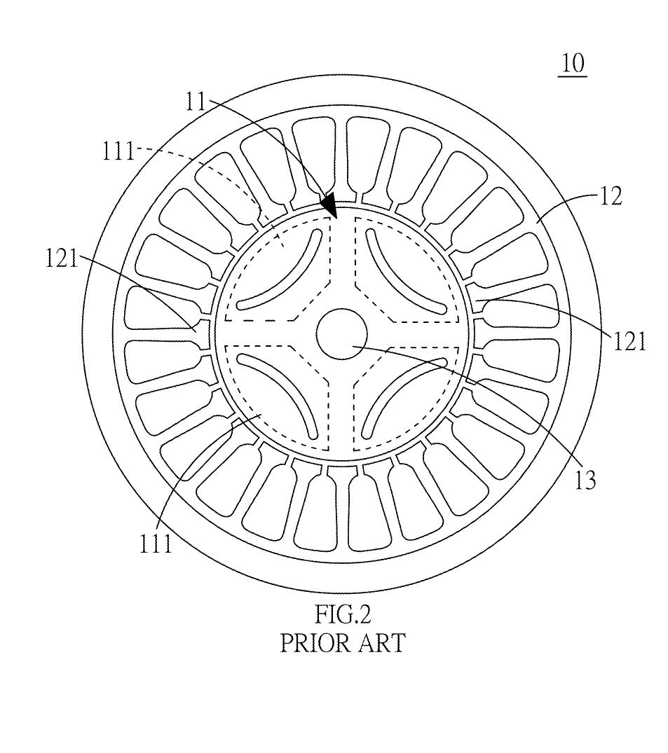

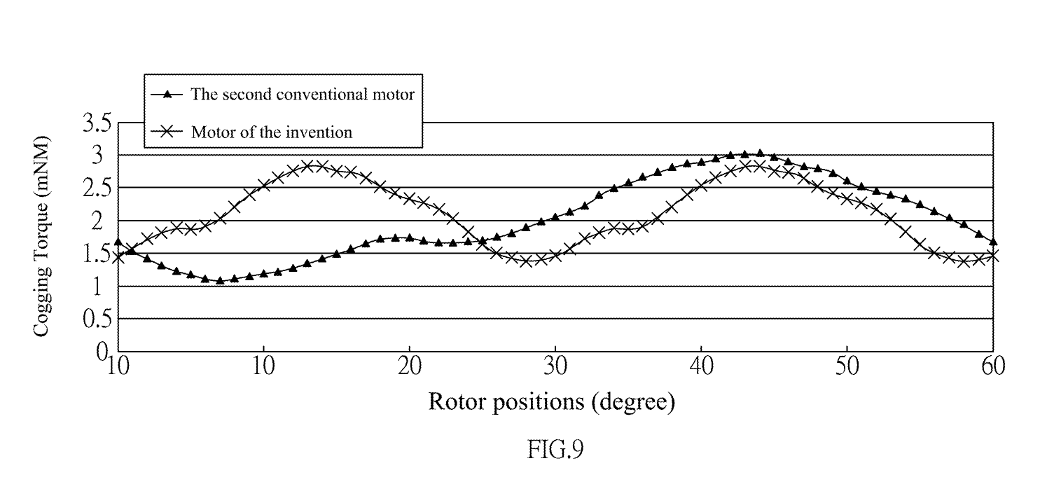

FIG. 9 is a Cogging Torque waveform of the corresponding rotor positions of the second known prior art (as shown in FIG. 2) and the embodiment of the present invention. The figure shows the embodiment of the present invention has denser Cogging Torque, lower amplitude, motor has lower vibration at slower speed.

Furthermore, a rivet holes 224 is on the rotor magnetic pole 221, the distance of the concave arc R1 and the rivet hole 224 is greater than 0.5 mm, the scheme enhances the structural strength of rotor 22, when rivet hole 224 is not applied and remain empty that reduces the inertia of the rotor 22 and serves as cooling purposes.

While a preferred embodiment of the invention has been shown and described in detail, it will be readily understood and appreciated that numerous omissions, changes and additions may be made without departing from the spirit and scope of the invention.

What is claimed is:

1. A motor having more magnets on effective area of the rotor, comprising:
a stator further consists a round shape main body and a plurality number of stator magnetic poles, said stator magnetic poles are protruding installed inside said round shape main body, a storage space is within each of said stator magnetic pole;
a rotor is slightly in plate round body and is installed inside the storage space and form air gap with each said stator magnetic pole, said rotor has an even number of rotor magnetic poles, magnets are inside each said rotor magnetic poles;
even number of magnets are each installed inside said rotor magnetic pole, a concave arc is on the outer side of each said magnet and forms the first, the second and the third surfaces near inside of each said magnet, said concave arc connects to said first and said third surfaces with a connecting plan respectively, each said connecting plan nears the periphery surface of said rotor, the angles formed by said first surface, said third surface and said second surface are θ1, and θ3 respectively, when the number of said rotor magnet poles is P that satisfies “90+ (180/P)” degree, the slope of the tangent of said concave arc near the end of said first surface is equal or smaller than the slope of said first surface, the slope of the tangent of said concave arc near the end of said third surface is equal or smaller than the slope of said third surface; and
a rotation shaft is installed on the center of said rotor and forms a body with said rotor.

2. The motor having more magnets on effective area of the rotor of claim 1, wherein said first surface and said third surface of adjacent said magnets are parallel to each other.

3. The motor having more magnets on effective area of the rotor of claim 1, where in a rivet holes is on said rotor magnetic pole.

4. The motor having more magnets on effective area of the rotor of claim 3, wherein the distance of said concave arc of said rotor magnetic pole and said rivet hole is greater than 0.5 mm.

5. The motor having more magnets on effective area of the rotor of claim 1, wherein the number of said rotor magnet poles P is even number, quantity of said stator magnetic poles is “P+ (P/2)”.

6. The motor having more magnets on effective area of the rotor of claim 1, wherein said magnets are made of iron oxide material.
